(19) United States
(12) Patent Application Publication
(10) Pub. No.: US 2025/0217196 A1
(43) Pub. Date: Jul. 3, 2025

(54) METHOD AND APPARATUS FOR SOLVING GRAPH MULTI-COLORING PROBLEM BASED ON QUANTUM APPROXIMATE OPTIMIZATION ALGORITHM

(71) Applicant: Korea University Research and Business Foundation, Seoul (KR)

(72) Inventors: Jun HEO, Seoul (KR); Gun Sik MIN, Seoul (KR)

(21) Appl. No.: 18/967,424

(22) Filed: Dec. 3, 2024

(30) Foreign Application Priority Data
Dec. 27, 2023 (KR) 10-2023-0193145
Jan. 24, 2024 (KR) 10-2024-0011107

(51) Int. Cl. G06F 9/50

(52) U.S. Cl. CPC G06F 9/5027

(57) ABSTRACT

The present invention relates to a technology for addressing resource allocation problems by solving the graph multi-coloring problem on a noisy intermediate-scale quantum (NISQ)-based quantum computer using a quantum approximate optimization algorithm (QAOA). A method of operation of a graph multi-coloring problem solving apparatus operated by a processor is provided.

### CROSS-REFERENCE TO RELATED PATENT APPLICATION

This application claims the benefit of Korean Patent Application No. 10-2023-0193145, filed on Dec. 27, 2023, and No. 10-2024-0011107, filed on Jan. 24, 2024, in the Korean Intellectual Property Office, the disclosure of which is incorporated herein in its entirety by reference.

### BACKGROUND OF THE INVENTION

### 1. Field of the Invention

The present invention relates to a technology for addressing resource allocation problems by solving the graph multi-coloring problem on a noisy intermediate-scale quantum (NISQ)-based quantum computer using a quantum approximate optimization algorithm (QAOA).

### 2. Description of the Related Art

Currently, quantum computer technology has been used to aid classical computers in complex data analysis tasks, such as chemical structure analysis and big data analysis, by utilizing a small number of qubits. Quantum computers with a large number of qubits are expected to be applied in various types of data analysis, as they can perform quantum algorithms and quantum machine learning.

Meanwhile, the quantum approximate optimization algorithm (QAOA) refers to a variational optimization technique for solving combinatorial optimization problems. Combinatorial optimization problems involve maximizing or minimizing a cost function for finite objective functions and are applied in various fields, including resource allocation and supply chain optimization.

In particular, the graph multi-coloring problem is one of the NP-complete problems, and solving the graph multi-coloring problem using quantum computing has the limitation that it requires a very high-dimensional input quantum state.

### REFERENCES OF THE RELATED ART

### Patent Document

Korean Patent Application Publication No.: 10-2023-0174676 (published on Dec. 28, 2023)

### Non-Patent Document

Y. Seo, Y. Kang, J. Park, and J. Heo, “A Complexity Reduction Method of Quantum Search Algorithm Applied to Single Graph Coloring Problem”, Proceedings of the Korean Institute of Communications and Information Sciences (KICS) Summer Conference 2020; VOL 70, NO. 01, PP. 0355.

### SUMMARY OF THE INVENTION

The present invention has been made in an effort to solve the above-described problems associated with prior art, and an object of the present invention is to provide a technology for solving a graph multi-coloring problem by designing a quantum approximate optimization algorithm that requires lower dimensional input quantum states compared to existing technologies.

Meanwhile, the technical objects of the present invention are not limited to those mentioned above, and other technical objects not mentioned will be clearly understood by those skilled in the art from the following description.

To achieve the aforementioned objects, an embodiment of the present invention provides a method of operation of a graph multi-coloring problem solving apparatus operated by a processor, the method comprising the operations of: obtaining a graph multi-coloring problem consisting of nodes and edges; assigning a qubit to each identification information i, j, which is a combination of the number of available colors j (where j represents the identification information of the number of available colors) for each node i (where i represents the identification information of the node); connecting a W-State gate between all qubits having the identification information of the same node; connecting a Cost Function Hamiltonian gate between two different qubits having the identification information of adjacent nodes; connecting an XY Hamiltonian gate between two different qubits having the identification information of the same node; and executing a quantum circuit, in which the W-State, Cost Function Hamiltonian, and XY Hamiltonian gates are connected, to derive the solution to the graph multi-coloring problem from the qubits.

The graph multi-coloring problem may include information about a graph structure consisting of nodes and edges, information about the number of available colors, and information about the rules for assigning different colors to nodes connected by edges in the graph structure.

The information about the graph structure may include information about the nodes V={v₁, v₂, . . . , vₙ} (where the subscript n represents the number of nodes) and information about the edges E={e₁, e₂, . . . , eₘ} (where the subscript m represents the number of edges); the information about the available colors may include information about the colors K={k₁, k₂, . . . , kₖ} (where the subscript k represents the number of available colors); and the information about the rules may be defined such that a set of colors that can be assigned to node vᵢ is set to Øᵥ_{ᵢ}^{K}={Øᵥ_{ᵢ}^{k}^{₁}, Øᵥ_{ᵢ}^{k}^{₂}, . . . , Øᵥ_{ᵢ}^{k}^{ₖ}}, where the value of Øᵥ_{ᵢ}^{k}^{₁} is 1 if node vᵢ is colored with color k₁, and the value of Øᵥ_{ᵢ}^{k}^{₁} is 0 if it is not colored, and where Øᵥ_{ᵢ}≠Øᵥ_{ⱼ} for nodes vᵢ and vⱼ connected by an edge.

The operation of assigning a qubit to each identification information may comprise: generating a number of qubits equal to the product of the number of nodes and the number of available colors; and matching and assigning each generated qubit to the corresponding identification information i, j.

The qubit may be set to |1> for a colorable state and |0> for a non-colorable state.

The W-State gate may include the design of a quantum circuit that outputs all available colors for a node as a quantum state.

The W-State gate may include the design of a quantum circuit that outputs all available colors for a node, from a case where there is only one available color for a specific node to a case where there are k available colors (where k represents the number of available colors), as qubits in a quantum state.

The Cost Function Hamiltonian gate may include the design of a quantum circuit that performs a Controlled ZZ operation between two different qubits having the identification information of the same node.

The XY Hamiltonian gate may include the design of a quantum circuit that performs the operation of Equation 1 below between two different qubits having the identification information of the same node:

$${H}_{XY} = \frac{1}{2} {\sum }_{i , j ∈ T} {σ}_{i}^{x} {σ}_{j}^{x} + {σ}_{i}^{y} {σ}_{j}^{y} \qquad [ Equation 1 ]$$

where i represents the identification information of the node, j represents the identification information of available colors, and T represents the set of all combinations of identification information i, j.

To achieve the aforementioned objects, another embodiment of the present invention provides an apparatus for solving a graph multi-coloring problem, the apparatus comprising: a memory having instructions stored thereon; and a processor performing predetermined operations based on the instructions, wherein the operations of the processor comprises: obtaining a graph multi-coloring problem consisting of nodes and edges; assigning a qubit to each identification information i, j, which is a combination of the number of available colors j (where j represents the identification information of the number of available colors) for each node i (where i represents the identification information of the node); connecting a W-State gate between all qubits having the identification information of the same node; connecting a Cost Function Hamiltonian gate between two different qubits having the identification information of adjacent nodes; connecting an XY Hamiltonian gate between two different qubits having the identification information of the same node; and executing a quantum circuit, in which the W-State, Cost Function Hamiltonian, and XY Hamiltonian gates are connected, to derive the solution to the graph multi-coloring problem from the qubits.

The present invention assigns a qubit to each identification information, which is a combination of the number of available colors for each node included in the graph multi-coloring problem, and designs a quantum circuit composed of qubits and the connected W-State, Cost Function Hamiltonian, and XY Hamiltonian gates. This enables the design of a quantum approximate optimization algorithm that requires a kⁿ dimensional input quantum state (where k represents the number of available colors and n represents the number of nodes). As a result, the present invention enables the execution of a resource allocation algorithm with low complexity on a small-scale quantum computer that requires solving the graph multi-coloring problem.

Meanwhile, the effects of the present invention are not limited to those mentioned above, and other technical effects not mentioned will be clearly understood by those skilled in the art from the following description.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an apparatus for solving a graph multi-coloring problem according to an embodiment;

FIG. 2 is a flowchart illustrating the operations performed by the apparatus for solving a graph multi-coloring problem according to an embodiment;

FIG. 3 is an exemplary diagram of a W-State gate according to an embodiment;

FIG. 4 is an exemplary diagram of a Cost Function Hamiltonian gate according to an embodiment;

FIG. 5 is an exemplary diagram of a Cost Function Hamiltonian gate according to an embodiment;

FIG. 6 is an exemplary diagram showing the connection of qubits with W-state, Cost Function Hamiltonian, and XY Hamiltonian gates according to an embodiment;

FIG. 7 is an exemplary diagram illustrating solutions derived from the graph multi-coloring problem input into a quantum circuit according to an embodiment; and

FIG. 8 is a diagram illustrating the performance of an embodiment of the present disclosure according to the number of nodes in the graph multi-coloring problem.

### DETAILED DESCRIPTION OF THE INVENTION

Details regarding the objects and technical features of the present invention and the resulting effects will be more clearly understood from the following detailed description based on the drawings attached to the specification of the present invention. Preferred embodiments according to the present invention will be described in detail with reference to the attached drawings.

The embodiments disclosed in this specification should not be construed or used as limiting the scope of the present invention. It is obvious to those skilled in the art that the description, including the embodiments, of this specification has various applications. Therefore, any embodiments described in the detailed description of the present invention are illustrative to better illustrate the present invention and are not intended to limit the scope of the present invention to the embodiments.

The functional blocks shown in the drawings and described below are only examples of possible implementations. In other implementations, different functional blocks may be used without departing from the spirit and scope of the detailed description. Moreover, although one or more functional blocks of the present invention are shown as individual blocks, one or more of the functional blocks of the present invention may be a combination of various hardware and software components that perform the same function.

Furthermore, the term “comprising” certain components, which is an “open-ended” term, simply refers to the presence of the corresponding components, and should not be understood as excluding the presence of additional components.

In addition, if a specific component is referred to as being “connected” or “coupled” to another component, it should be understood that it may be directly connected or coupled to another other component, but there may be other components therebetween.

Hereinafter, various embodiments of the present invention will be described with reference to the attached drawings. However, this is not intended to limit the present invention to specific embodiments, but it should be understood to include various modifications, equivalents, and/or alternatives of the embodiments of the present invention.

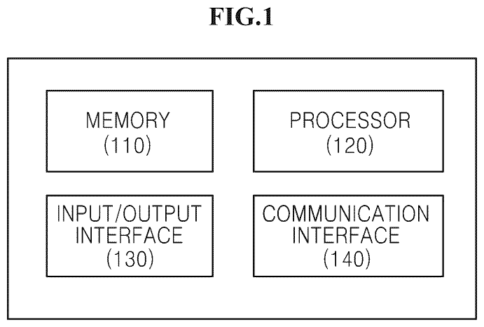

FIG. 1 is a block diagram of an apparatus 100 for solving a graph multi-coloring problem according to an embodiment (hereinafter referred to as “apparatus 100”).

Referring to FIG. 1, the apparatus 100 according to an embodiment may comprise a memory 110, a processor 120, an input/output interface 130, and a communication interface 140.

The memory 110 may store data obtained from an external device or data generated internally. The memory 110 may store instructions to execute the operations of the processor 120. Moreover, the memory 110 may store information on the graph multi-coloring problem, which will be described later.

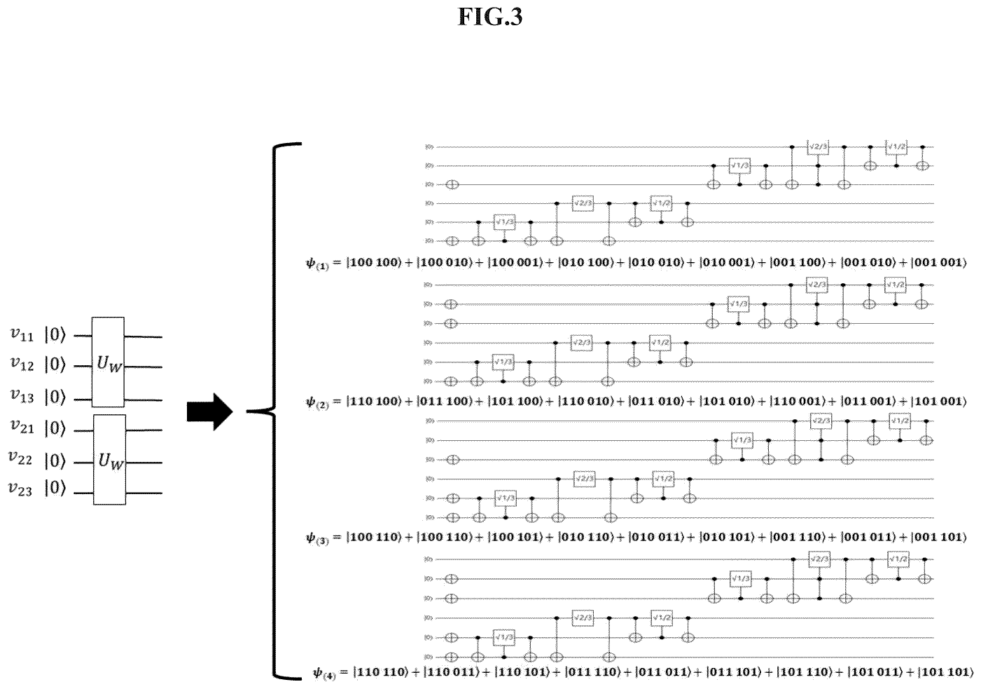

The processor 120 is an operational device that controls overall operations. The processor 120 may execute the instructions stored in the memory 110. In accordance with the embodiment of the present disclosure, the operations of the apparatus 100 shown in FIG. 3, which will be described later, can be understood as being performed by the processor 120.

The input/output interface 130 may include a hardware interface or software interface for inputting or outputting information.

The communication interface 140 enables transmission and reception of information over a communication network. To this end, the communication interface 140 may include a wireless communication module or a wired communication module.

The apparatus 100 may be implemented in various types of devices capable of performing the operations via the processor 120 and transmitting and receiving information through a network. For example, it may be implemented as a server, a computer device, quantum computing device, portable communication device, smartphone, portable multimedia device, laptop, tablet PC, etc., but is not limited to these examples. Here, a quantum computing device is a computing device that processes data using phenomena related to quantum mechanics, such as quantum entanglement and quantum superposition. Quantum entanglement may refer to a state in which two or more states are quantum-mechanically correlated, making it impossible to treat each state independently. Quantum superposition may refer to the phenomenon where multiple possible outcome states exist probabilistically at the same time, before a quantum state is measured. The quantum computing device can use qubits as the basic units of information to process data, utilizing phenomena related to quantum mechanics.

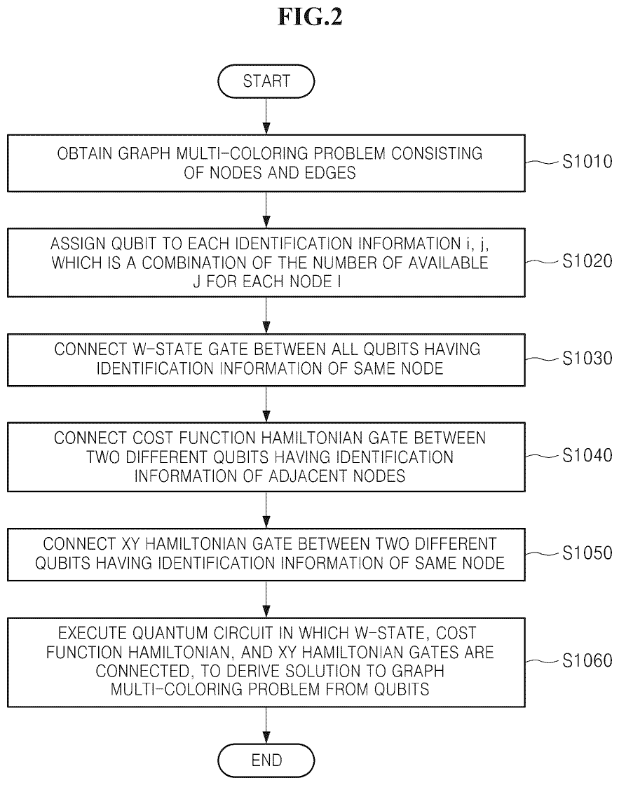

A qubit can utilize quantum superposition to represent values corresponding to multiple bits simultaneously. For example, a qubit can represent the values probabilistically, such as ‘0 with a 20% probability and 1 with an 80% probability.’ When a qubit is observed, the quantum superposition collapses, and it is found to be a single state. Each qubit can undergo specific operations through quantum gates, which perform operations based on the input state of the qubit. A design consisting of qubits and quantum gates is referred to as a quantum circuit. The following FIG. 2 illustrates the operation of the apparatus 100 in designing a quantum circuit composed of qubits and quantum gates to solve the graph multi-coloring problem.

FIG. 2 is a flowchart illustrating the operations performed by the apparatus 100 according to an embodiment. The operations of the apparatus 100 in the embodiment of FIG. 2 can be understood as being performed by the processor 120.

Each step shown in FIG. 2 is merely a preferred embodiment for achieving the objectives of the present invention, and certain steps may be added or deleted as needed. Additionally, one step may be performed as part of another step. The order of the operations shown in FIG. 2 is arranged for convenience of understanding, and this order is not limited to a chronological sequence. The order may be modified and executed differently depending on the designer's choice.

In step S1010, the apparatus 100 may obtain a graph multi-coloring problem consisting of nodes and edges. The graph multi-coloring problem refers to the task of coloring all nodes in a graph structure, which consists of nodes and edges, using a predetermined number of colors, such that no two nodes connected by an edge share the same color. The apparatus 100 may receive information about the graph structure consisting of nodes and edges, information about the number of available colors, and information about the rules for assigning different colors to nodes connected by edges in the graph structure.

For example, the information about the graph structure may include information about the nodes V={v₁, v₂, . . . , vₙ} (where the subscript n represents the number of nodes) and information about the edges E={e₁, e₂, . . . , eₘ} (where the subscript m represents the number of edges). The information about the available colors may include information about the colors K={k₁, k₂, . . . , kₖ} (where the subscript k represents the number of available colors). The information about the rules for the graph multi-coloring problem may be defined such that a set of colors that can be assigned to node vᵢ is set to Øᵥ_{ᵢ}^{K}={Øᵥ_{ᵢ}^{k}^{₁}, Øᵥ_{ᵢ}^{k}^{₂}, . . . Øᵥ_{ᵢ}^{k}^{ₖ}}, where the value of Øᵥ_{ᵢ}^{k}^{₁} is 1 if node vᵢ is colored with color k₁, and the value of Øᵥ_{ᵢ}^{k}^{₁} is 0 if it is not colored, and where Øᵥ_{ᵢ}≠Øᵥ_{ⱼ} for nodes vᵢ and vⱼ connected by an edge.

For the convenience of understanding, the description of the present disclosure will illustrate the graph multi-coloring problem using an example where there are two nodes V={v₁, v₂}, one edge E={e₁} connecting two nodes, and three available colors K={k₁, k₂, k₃}. The embodiment of the present disclosure can be applied in the same manner to various cases with different numbers of nodes, edges, and available colors, which will be described later.

In step S1020, the apparatus 100 can assign a qubit to each identification information i, j, which is a combination of the number of available colors j (where j represents the identification information of the number of available colors) for each node i (where i represents the identification information of the node). For example, the apparatus 100 may generate a number of qubits equal to the product of the number of nodes and the number of available colors, and then match and assign each generated qubit to the corresponding identification information i, j.

As an example, if there are two nodes V={v₁, v₂} and three available colors K={k₁, k₂, k₃}, six qubits can be generated. These qubits can then be matched and assigned to the identification information i, j, resulting in v₁₁, v₁₂, v₁₃, v₂₁, v₂₂, and v₂₃. The apparatus 100 can set the state information of each qubit as follows. For example, the apparatus 100 can set a specific qubit to |1> for a colorable state and |0> for a non-colorable state. For example, if the node 11 can be colored with k₁ and k₂, and the node 12 can be colored with k₃, the apparatus 100 can set the state of the qubits for the nodes {v₁, v₁₂, v₁₃, v₂₁, v₂₂, v₂₃} to |110 001>.

In step S1030, the apparatus 100 may connect a W-State gate between all qubits having the identification information of the same node.

FIG. 3 is an exemplary diagram of a W-State gate according to an embodiment.

Referring to FIG. 3, if there are two nodes V={v₁, v₂} and three available colors K={k₁, k₂, k₃}, the apparatus 100 can connect a W-State gate between the qubits v₁₁, v₁₂, and v₁₃, which have the same node information 11, and connect a W-State gate between the qubits v₂₁, v₂₂, and v₂₃, which have the same node information v₂. The method of connecting the W-State gate between the qubits using can refer to known techniques for W-State.

According to the W-State gate of FIG. 3, the qubits can represent all available colors for a given node as a quantized state. That is, the W-State gate can represent the number of available colors for a specific node, ranging from one color to k colors (where k represents the number of available colors), as qubits in a quantum state.

In step S1040, the apparatus 100 may connect a Cost Function Hamiltonian gate between two different qubits having the identification information of adjacent nodes.

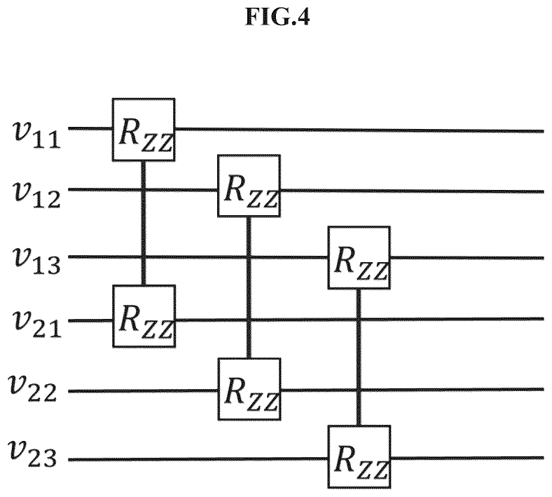

FIG. 4 is an exemplary diagram of a Cost Function Hamiltonian gate according to an embodiment.

Referring to FIG. 4, if there are two nodes V={v₁, v₂} and three available colors K={k₁, k₂, k₃}, the apparatus 100 can connect a Cost Function Hamiltonian gate between two qubits (e.g., v₁₁ and v₂₁; v₁₂ and v₂₂; v₁₃ and v₂₃) having different identification information of adjacent nodes. The method of connecting the Cost Function Hamiltonian gates between the qubits can refer to known techniques for Cost Function Hamiltonian.

The Cost Function Hamiltonian gate shown in FIG. 4 can perform a controlled ZZ operation on the qubits of different nodes. Here, the controlled ZZ operation is a quantum operator that forms part of the Ising Hamiltonian.

In step S1050, the apparatus 100 can connect an XY Hamiltonian gate between two different qubits having the identification information of the same node.

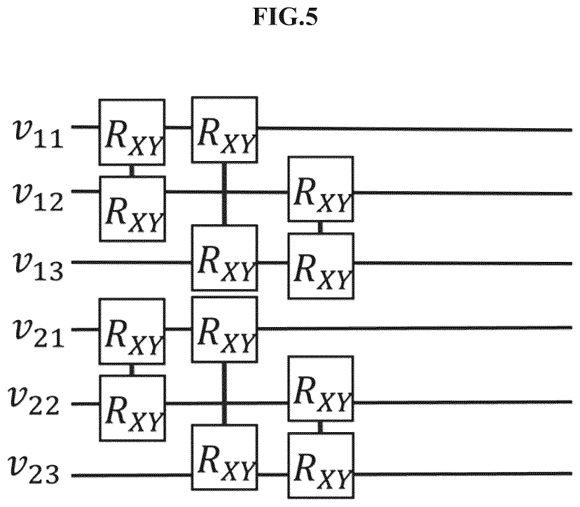

FIG. 5 is an exemplary diagram of a Cost Function Hamiltonian gate according to an embodiment.

Referring to FIG. 5, if there are two nodes V={v₁, v₂} and three available colors K={k₁, k₂, k₃}, the apparatus 100 can connect an XY Hamiltonian gate between two different qubits having the identification information of the same node (e.g., v₁₁ and v₁₂; v₁₁ and v₁₃; v₁₂ and v₁₃; v₂₁ and v₂₂; v₂₁ and v₂₃; v₂₂ and v₂₃). The method of connecting the XY Hamiltonian gate between the qubits can refer to known techniques for XY Hamiltonian.

According to the XY Hamiltonian gate shown in FIG. 5, the operation in Equation 1 below can be performed between two different qubits having the identification information of the same node:

$${H}_{XY} = \frac{1}{2} {\sum }_{i , j ∈ T} {σ}_{i}^{x} {σ}_{j}^{x} + {σ}_{i}^{y} {σ}_{j}^{y} \qquad [ Equation 1 ]$$

where i represents the identification information of the same node, j represents the identification information of available colors, T represents the set of all combinations of identification information i, j, x represents one of the quantum operation gates, specifically a Pauli X gate, expressed as

$$[ \begin{matrix}0 & 1 \\ 1 & 0\end{matrix} ] ,$$

and y represents one of the quantum operation gates, specifically a Pauli Y gate, expressed as

$$[ \begin{matrix}0 & - i \\ i & 0\end{matrix} ] .$$

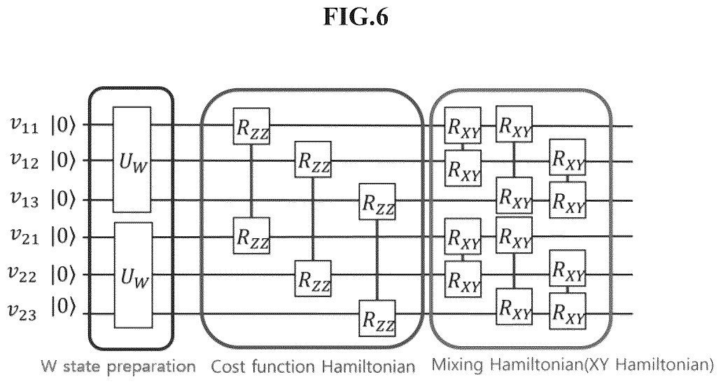

FIG. 6 is an exemplary diagram showing the connection of qubits with W-state, Cost Function Hamiltonian, and XY Hamiltonian gates according to an embodiment.

Referring to FIG. 6, in step S1060, the apparatus 100 may execute the quantum circuit, in which the aforementioned W-state, Cost Function Hamiltonian, and XY Hamiltonian gates are connected, to derive the solution to the graph multi-coloring problem from the assigned qubits based on the graph multi-coloring problem.

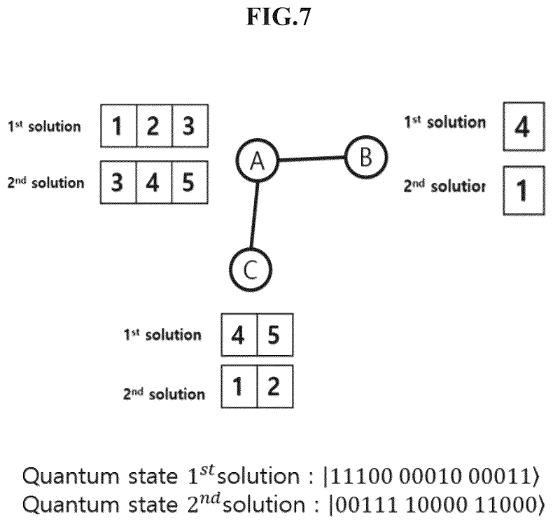

FIG. 7 is an exemplary diagram illustrating solutions derived from the graph multi-coloring problem input into a quantum circuit according to an embodiment.

Referring to FIG. 7, if there are three nodes, A, B, and C, two edges connecting A-B and A-C, and five available colors K={1, 2, 3, 4, 5}, according to the embodiment of the present disclosure, the solutions |11100 00010 00011> and |00111 10000 11000> can be derived.

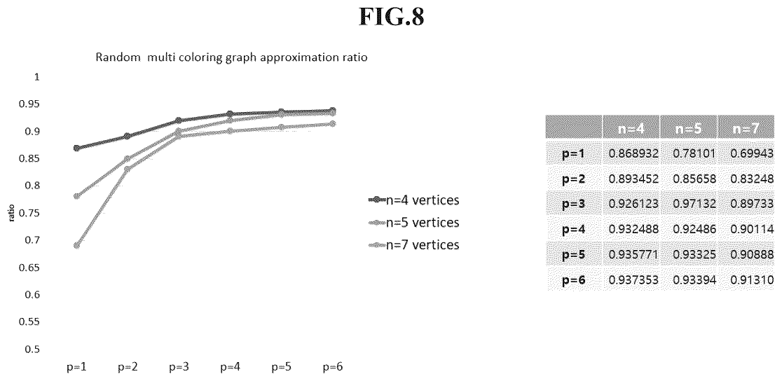

FIG. 8 is a diagram illustrating the performance of an embodiment of the present disclosure according to the number of nodes in the graph multi-coloring problem.

Referring to FIG. 8, the embodiment of the present disclosure was applied to solve the graph multi-coloring problem using IBM Qiskit. Here, n represents the number of nodes in the graph, and p represents the steps of the algorithm. The steps of the algorithm indicate the number of operation repetitions, specifically how many times the quantum circuit operations and classical parameter optimization were repeated. The ratio refers to the approximation ratio, which expresses how close the quantum state is to the solution of the problem as a ratio. The closer this value is to 1, the closer it is to the solution of the problem.

The present invention assigns a qubit to each identification information, which is a combination of the number of available colors for each node included in the graph multi-coloring problem, and designs a quantum circuit composed of qubits and the connected W-State, Cost Function Hamiltonian, and XY Hamiltonian gates. This enables the design of a quantum approximate optimization algorithm that requires a kⁿ dimensional input quantum state (where k is the number of available colors and n is the number of nodes). As a result, the present invention enables the execution of a resource allocation algorithm with low complexity on a small-scale quantum computer that requires solving the graph multi-coloring problem.

It should be understood that the various embodiments and terms used herein are not intended to limit the technical features described herein to specific embodiments, but are instead meant to encompass various modifications, equivalents, or alternatives of the embodiments. In the description of the drawings, similar or related components may be denoted by similar reference numerals. The singular form of a noun corresponding to an item may refer to one or more items, unless the context clearly indicates otherwise.

As used herein, the phrases “A or B”, “at least one of A and B”, “at least one of A or B,” “A, B, or C,” “at least one of A, B, and C,” and “at least one of A, B, or C” may include all possible combinations of the items listed in the corresponding phrase. The terms “first”, “second”, etc. may be used merely to distinguish one component from another, without limiting the components in other aspects (e.g., in terms of importance or order). When a certain (e.g., first) component is referred to as being “coupled” or “connected” to another (e.g., second) component, with or without the terms “functionally” or “communicatively,” it means that the component may be connected to the other component directly (e.g., via wired connection), wirelessly, or through a third component.

As used herein, the term “module” may include a unit implemented in hardware, software or firmware, and may be used interchangeably with terms such as logic, logic block, component, or circuit. A module may be a single integral component, or a minimum unit or part thereof, adapted to perform one or more functions. For example, according to an embodiment, the module may be implemented in the form of an application-specific integrated circuit (ASIC).

Various embodiments of the present disclosure may be implemented as software (e.g., a program) comprising one or more instructions stored on a storage medium (e.g., a memory) that can be read by a device (e.g., an electronic device). The storage medium may include a random access memory (RAM), a memory buffer, a hard drive, a database, erasable programmable read-only memory (EPROM), electrically erasable read-only memory (EEPROM), read-only memory (ROM), and/or the like.

Moreover, the processor in the embodiments of the present disclosure may retrieve and execute at least one instruction from one or more instructions stored on the storage medium. This enables the device to perform at least one function according to the at least one retrieved instruction. The one or more instructions may include a code generated by a compiler or a code executable by an interpreter. The processor may be a general-purpose processor, a Field Programmable Gate Array (FPGA), an Application Specific Integrated Circuit (ASIC), a Digital Signal Processor (DSP), and/or the like.

A machine-readable storage medium may be provided in the form of a non-transitory storage medium. Here, the term “non-transitory” means that the storage medium is a tangible device that does not contain signals (e.g., electromagnetic waves), and this term does not distinguish between cases where data is stored semi-permanently or temporarily on the storage medium.

The methods according to various embodiments disclosed herein may be provided as part of a computer program product. The computer program product may be traded as a commodity between a seller and a buyer. The computer program product may be distributed in the form of a machine-readable storage medium (e.g., compact disc read-only memory (CD-ROM)), or it may be distributed (e.g., download or upload) online through an application store (e.g., Play Store) or directly between two user devices (e.g., smartphones). In the case of online distribution, at least a portion of the computer program product may be temporarily stored or generated on a machine-readable storage medium, such as the manufacturer's server, an application store's server, or a server's memory.

According to various embodiments, each of the described components (e.g., modules or programs) may include a singular or plural number of entities. In accordance with various embodiments, one or more of the aforementioned components or operations may be omitted, or one or more other components or operations may be added. Alternatively or additionally, a plurality of components (e.g., modules or programs) may be integrated into a single component. In such a case, the integrated component may perform one or more functions of each of the plurality of components in the same or similar manner as each of the components would perform prior to integration. According to various embodiments, operations performed by a module, program, or other component may be carried out sequentially, in parallel, repeatedly, or heuristically, or one or more of the operations may be executed in a different order or omitted, or one or more other operations may be added.

### BRIEF DESCRIPTION OF REFERENCE NUMERALS

100: apparatus
110: memory
120: processor
130: input/output interface
140: communication interface

While the invention has been shown and described with reference to certain preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A method of operation of a graph multi-coloring problem solving apparatus operated by a processor, the method comprising the operations of:
obtaining a graph multi-coloring problem consisting of nodes and edges;
assigning a qubit to each identification information i, j, which is a combination of the number of available colors j (where j represents the identification information of the number of available colors) for each node i (where i represents the identification information of the node);
connecting a W-State gate between all qubits having the identification information of the same node;
connecting a Cost Function Hamiltonian gate between two different qubits having the identification information of adjacent nodes;
connecting an XY Hamiltonian gate between two different qubits having the identification information of the same node; and
executing a quantum circuit, in which the W-State, Cost Function Hamiltonian, and XY Hamiltonian gates are connected, to derive the solution of the graph multi-coloring problem from the qubits.

2. The method according to claim 1, wherein the graph multi-coloring problem includes information about a graph structure consisting of nodes and edges, information about the number of available colors, and information about the rules for assigning different colors to nodes connected by edges in the graph structure.

3. The method according to claim 2, wherein the information about the graph structure includes information about the nodes V={v₁, v₂, . . . , vₙ} (where the subscript n represents the number of nodes) and information about the edges E={e₁, e₂, . . . , eₘ} (where the subscript m represents the number of edges),
wherein the information about the available colors includes information about the colors K={k₁, k₂, . . . , kₖ} (where the subscript k represents the number of available colors), and
wherein the information about the rules is defined such that a set of colors that can be assigned to node vᵢ is set to Øᵥ_{ᵢ}^{K}={Øᵥ_{ᵢ}^{k}^{₁}, Øᵥ_{ᵢ}^{k}^{₂}, . . . , Øᵥ_{ᵢ}^{k}^{ₖ}} where the value of Øᵥ_{ᵢ}^{k}^{₁} is 1 if node vᵢ is colored with color k₁, and the value of Øᵥ_{ᵢ}^{k}^{₁} is 0 if it is not colored, and where Øᵥ_{ᵢ}≠Øᵥ_{ⱼ} for nodes vᵢ and vⱼ connected by an edge.

4. The method according to claim 1, wherein the operation of assigning a qubit to each identification information comprises:
generating a number of qubits equal to the product of the number of nodes and the number of available colors; and
matching and assigning each generated qubit to the corresponding identification information i, j.

5. The method according to claim 1, wherein the qubit is set to |1> for a colorable state and |0> for a non-colorable state.

6. The method according to claim 5, wherein the W-State gate includes the design of a quantum circuit that outputs all available colors for a node as a quantum state.

7. The method according to claim 6, wherein the W-State gate includes the design of a quantum circuit that outputs all available colors for a node, from a case where there is only one available color for a specific node to a case where there are k available colors (where k represents the number of available colors), as qubits in a quantum state.

8. The method according to claim 1, wherein the Cost Function Hamiltonian gate includes the design of a quantum circuit that performs a Controlled ZZ operation between two different qubits having the identification information of the same node.

9. The method according to claim 1, wherein the XY Hamiltonian gate includes the design of a quantum circuit that performs the operation of Equation 1 below between two different qubits having the identification information of the same node:
$${H}_{XY} = \frac{1}{2} {\sum }_{i , j ∈ T} {σ}_{i}^{x} {σ}_{j}^{x} + {σ}_{i}^{y} {σ}_{j}^{y} \qquad [ Equation 1 ]$$
where i represents the identification information of the node, j represents the identification information of available colors, T represents the set of all combinations of identification information i, j.

10. An apparatus for solving a graph multi-coloring problem, the apparatus comprising:
a memory having instructions stored thereon; and
a processor performing predetermined operations based on the instructions,
wherein the operations of the processor comprises:
obtaining a graph multi-coloring problem consisting of nodes and edges;
assigning a qubit to each identification information, which is a combination of the number of available colors j (where j represents the identification information of the number of available colors) for each node i (where i represents the identification information of the node);
connecting a W-State gate between all qubits having the identification information of the same node;
connecting a Cost Function Hamiltonian gate between two different qubits having the identification information of adjacent nodes;
connecting an XY Hamiltonian gate between two different qubits having the identification information of the same node; and
executing a quantum circuit, in which the W-State, Cost Function Hamiltonian, and XY Hamiltonian gates are connected, to derive the solution of the graph multi-coloring problem from the qubits.
